(19) United States
(12) Patent Application Publication
(10) Pub. No.: US 2026/0056044 A1
(43) Pub. Date: Feb. 26, 2026

(54) SELF-POWERED WATER METER AND POWER GENERATION MODULE THEREOF

(71) Applicant: HANGZHOU GUANGDI TECHNOLOGY CO., LTD., Hangzhou, Zhejiang Province (CN)

(72) Inventors: Dong LIN, Hangzhou, Zhejiang (CN); Fuwei ZHU, Hangzhou, Zhejiang (CN)

(21) Appl. No.: 18/997,029

(22) PCT Filed: Dec. 29, 2023
(86) PCT No.: PCT/CN2023/143645

§ 371 Date: Jan. 18, 2025

(30) Foreign Application Priority Data
Jan. 19, 2023 (CN) 202310117358.1

(51) Int. Cl. G01F 15/063; H02K 7/18; H02K 11/00

(52) U.S. Cl. CPC G01F 15/063; H02K 7/1823; H02K 11/0094

(57) ABSTRACT

A self-powered water meter and a power generation module (3) thereof. The self-powered water meter includes a housing (1), an intelligent water meter module (2), and a power generating module (3). The housing (1) has a first cavity (11) and a second cavity (12), and the second cavity (12) communicates with the first cavity (11). The intelligent water meter module (2) is mounted in the first cavity (11). The power generating module (3) is mounted in the second cavity (12). The power generating module (3) includes a generator (31), a first flow guide structure (32), and a power generating impeller (33). The first flow guide structure (32) includes a set of first guide vanes (321). The number of the first guide vanes (321) is 10-60. Each of the first guide vanes (321) has a first blade bending angle, and the first blade bending angle is 50-75 degrees. The first flow guide structure (32) guides a water flow to the power generating impeller (33), and the power generating impeller (33) rotates such that the generator (31) generates power.

### TECHNICAL FIELD

The present invention pertains to the field of water meters, and particularly relates to a self-powered water meter and a power generating module thereof.

### BACKGROUND

With the development of technology, intelligent water meters have been used increasingly. In addition to recording and electronically displaying water usage, intelligent water meters can also control water usage according to agreements, automatically complete tiered water price calculations, and perform functions such as storage and remote transmission of water usage data. To facilitate the collection of water meter readings from water usage terminals by water supply units, the prior art involves the combination of conventional mechanical water meters with intelligent water meters. An intelligent water meter reads the flow rate measured by a conventional mechanical water meter and then remotely transmits a corresponding reading to a terminal, thereby achieving intelligent remote meter reading. However, existing intelligent water meters are powered by built-in batteries. Due to the limited battery power, sometimes the structural circuit of the intelligent water meter is still within its quality service life, but the battery power is exhausted, requiring manual replacement of the battery. In the practical application, to ensure the accuracy of meter reading, before the battery is completely exhausted, the battery is replaced manually at regular intervals based on the estimated remaining battery power. Each battery replacement requires the arrangement of specialized personnel, increasing both battery and labor costs. Moreover, during the period when the intelligent water meter is powered off and then restarted, a data error is likely to occur. Particularly, the replaced battery causes significant environmental pollution.

To resolve the above problems, self-powered water meters are designed. In the prior art, an external micro-engine is typically added to convert the kinetic energy of water flow into electrical energy to charge an energy storage apparatus. However, in the prior art, the problem of additional pressure loss caused by the added micro-generator is overlooked. The new national standard for water meters, GB/778.1-2007, stipulates that at a given flow rate, a water head loss caused by the presence of a water meter in a pipeline is called pressure loss. Under a water flowing condition, the pressure at an outlet end of a water meter is less than the pressure at an inlet end. The new standard stipulates that the maximum pressure loss of the water meter under a rated working condition should not exceed 0.063 MPa, meaning that the pressure loss of the water meter under a condition of a normal flow rate should not exceed 0.063 MPa.

The pressure loss is an important parameter of the water meter, and water meters that do not meet the pressure loss conditions cannot be practically used. If the water meter is to be self-powered, a power generating module needs to be added, which however inevitably increases the pressure loss of the water meter. On the premise of minimizing the increase in pressure loss, ensuring power generation under a condition of a small water flow has become the biggest obstacle to the commercial promotion and application of self-powered water meters.

### SUMMARY OF THE INVENTION

In order to overcome at least one deficiency in the prior art, the present invention provides a self-powered water meter and a power generating module thereof.

In order to achieve an object of the present invention, the present invention provides a self-powered water meter, including a housing, an intelligent water meter module, and a power generating module. The housing has a first cavity and a second cavity, and the second cavity communicates with the first cavity. The intelligent water meter module is mounted in the first cavity. The power generating module is mounted in the second cavity. The power generating module includes a generator, a first flow guide structure, and a power generating impeller. The first flow guide structure includes a set of first guide vanes, 10-60 first guide vanes are provided, each of the first guide vanes has a first blade bending angle, the first blade bending angle is 50-75 degrees, the first flow guide structure guides a water flow towards the power generating impeller, and the power generating impeller rotates such that the generator generates power.

In an embodiment of the present invention, the power generating impeller includes a set of power generating blades, 10-60 power generating blades are provided, each of the power generating blades is an asymmetric blade, each of the power generating blades has a second blade bending angle, and the second blade bending angle is 15-40 degrees.

In an embodiment of the present invention, the power generating impeller includes a set of power generating blades, 10-60 power generating blades are provided, each of the power generating blades is a symmetric blade, each of the power generating blades has a second blade bending angle, and the second blade bending angle is 0-60 degrees.

In an embodiment of the present invention, the power generating module further includes a second flow guide structure, the second flow guide structure guides the water flow to the first flow guide structure, the second flow guide structure includes a set of second guide vanes, 10-40 second guide vanes are provided, each of the second guide vanes has a blade inclination angle, and the blade inclination angle is 10-60 degrees.

In an embodiment of the present invention, the second flow guide structure guides the water flow from top to bottom to the first flow guide structure, and the first flow guide structure guides the water flow from top to bottom to the power generating impeller.

In an embodiment of the present invention, a quantity of the second guide vanes is less than a quantity of the first guide vanes, and a blade gap between the second guide vanes is greater than a blade gap between the first guide vanes.

In an embodiment of the present invention, the second cavity communicates with the first cavity via a through hole, and a diameter of the through hole is substantially consistent with an inner diameter of an external water pipe of the self-powered water meter.

In order to achieve another object of the present invention, the present invention further provides a power generating module of a self-powered water meter, including a generator, a first flow guide structure, and a power generating impeller. The first flow guide structure includes a set of first guide vanes, 10-60 first guide vanes are provided, each of the first guide vanes has a first blade bending angle, the first blade bending angle is 50-75 degrees, the first flow guide structure guides a water flow towards the power generating impeller, and the power generating impeller rotates such that the generator generates power.

In an embodiment of the present invention, the power generating module further includes a second flow guide structure, the second flow guide structure guides the water flow to the first flow guide structure, the second flow guide structure includes a set of second guide vanes, 10-40 second guide vanes are provided, each of the second guide vanes has a blade inclination angle, and the blade inclination angle is 10-60 degrees.

In an embodiment of the present invention, the power generating impeller includes a set of power generating blades, 10-60 power generating blades are provided, each of the power generating blades is an asymmetric blade, each of the power generating blades has a second blade bending angle, and the second blade bending angle is 15-40 degrees.

In an embodiment of the present invention, the power generating impeller includes a set of power generating blades, 10-60 power generating blades are provided, each of the power generating blades is a symmetric blade, each of the power generating blades has a second blade bending angle, and the second blade bending angle is 0-60 degrees.

In summary, the present invention reduces turbulence in the second cavity by disposing a first flow guide structure and a power generating impeller, reducing pressure loss as much as possible, and directing the water flow towards the power generating impeller at a specific angle. Even in a case of a small water flow, a sufficient power generating capacity can be still provided for the intelligent water meter module, thereby ensuring the normal operation of the intelligent water meter (for example, remote meter reading). The present invention, through the combination of the first flow guide structure and the power generating impeller, ensures that the overall pressure loss of the self-powered water meter is within the national standard range and that the self-powered water meter can still generate power under a condition of a small water flow, making the commercial application and promotion of the self-powered water meter possible. The self-powered water meter provided by the present invention can self-start to generate power at a low water speed, and the power generation is efficient without significantly increasing pressure loss.

In order to make the above and other objects, features and advantages of the present invention more obvious and understandable, the following is a detailed description of the preferred embodiments, together with the accompanying drawings.

### DESCRIPTION OF THE DRAWINGS

FIG. 1 is a partially sectional side view of a self-powered water meter according to an embodiment of the present invention.

FIG. 2 is a partially sectional view along direction A-A in FIG. 1.

FIG. 3 is a schematic three-dimensional view of the self-powered water meter according to an embodiment of the present invention.

FIG. 4 is a longitudinal, three-dimensional, and sectional view of a first flow guide structure and a second flow guide structure according to an embodiment of the present invention.

FIG. 5 is a longitudinal sectional front view of the first flow guide structure and the second flow guide structure according to an embodiment of the present invention.

FIG. 6 is a sectional view along direction B-B in FIG. 5.

FIG. 7 is a schematic diagram of a first guide vane according to an embodiment of the present invention.

FIG. 8 is a three-dimensional view of a power generating impeller according to an embodiment of the present invention.

FIG. 9 is a front view of the power generating impeller according to an embodiment of the present invention.

FIG. 10 is a schematic diagram of a power generating blade according to an embodiment of the present invention.

FIG. 11 is a three-dimensional view of the power generating impeller according to another embodiment of the present invention.

FIG. 12 is a front view of the power generating impeller according to another embodiment of the present invention.

FIG. 13 is a schematic diagram of a power generating blade according to another embodiment of the present invention.

### DETAILED DESCRIPTION OF EMBODIMENTS

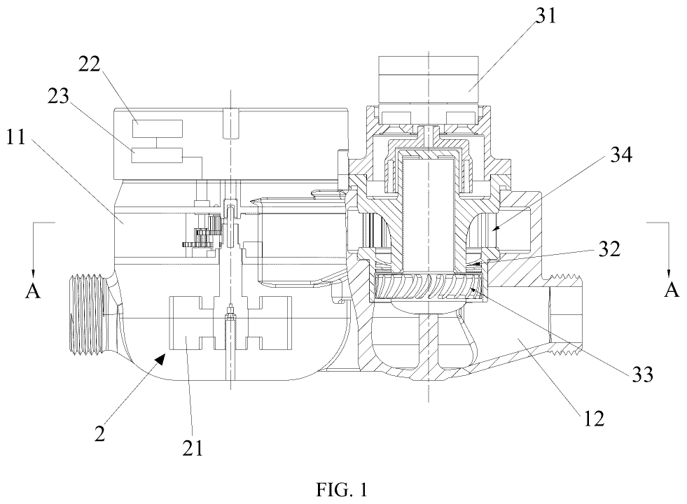

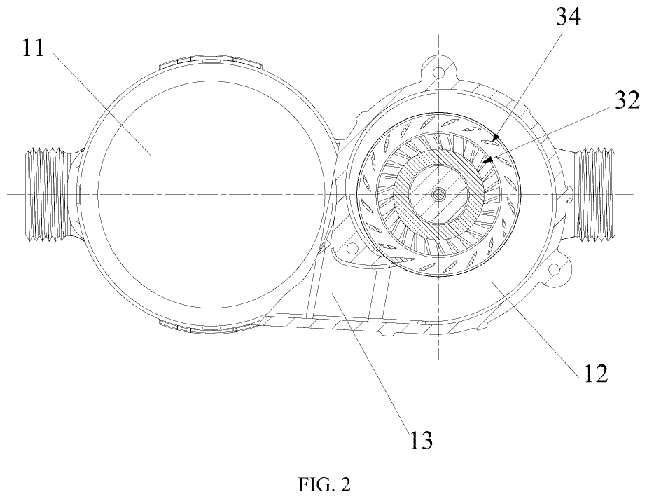

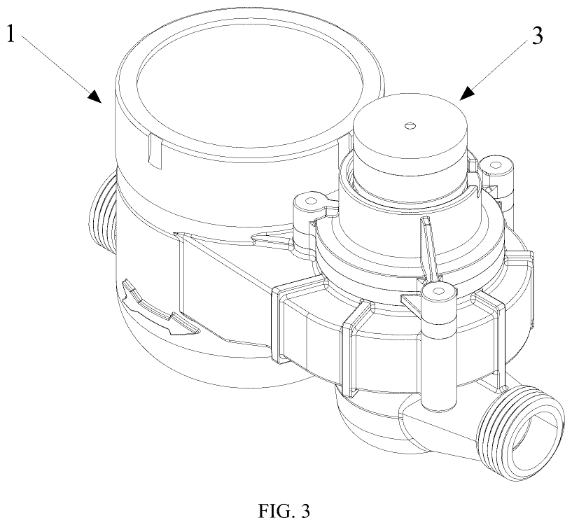

As shown in FIGS. 1-3, the present invention provides a self-powered water meter, including a housing 1, an intelligent water meter module 2, and a power generating module 3. The housing 1 has a first cavity 11 and a second cavity 12, and the second cavity 12 communicates with the first cavity 11. The intelligent water meter module 2 is mounted in the first cavity 11. The power generating module 3 is mounted in the second cavity 12. The first cavity 11 and the second cavity 12 are integrally formed. The second cavity 12 communicates with the first cavity 11 via a through hole 13.

In the prior art, the through hole is set to a small diameter (for example, 4-6 mm), increasing the water outflow speed, such that the water more quickly rushes to the power generating impeller, thereby increasing the electricity generating power. This ensures there is still a power generation capacity at a small water flowing speed, but a significant increase in pressure loss is ignored. In this embodiment, the second cavity 12 communicates with the first cavity 11 via a large-diameter through hole, ensuring that the water quickly flows out of the first cavity 11, reducing obstructions, thereby reducing pressure loss. In this embodiment, the diameter of the through hole is substantially equal to the inner diameter of an external water pipe of the self-powered water meter. For example, the inner diameter of a typical water pipe is 15 mm, and the diameter of the through hole in this embodiment is 15 mm. Setting the diameter of the through hole to be substantially equal to the inner diameter of the water pipe minimizes the increase in pressure loss during the flow of water from the water pipe into the first cavity and then into the second cavity from the first cavity. However, the present invention does not limit the specific diameter of the through hole 13. In other embodiments, the diameter of the through hole may be 12 mm, 13 mm, 16 mm, or the like.

The intelligent water meter module 2 includes a metering module 21, an energy storage module 22, and a data transmission module 23. The metering module 21 includes a metering impeller and a gear set. The energy storage module 22 may be a lithium-ion battery or a supercapacitor. The data transmission module 23 is a circuit structure capable of transmitting data remotely on a network. The power generating module 3 supplies generated power to the energy storage module 22, the energy storage module 22 provides power to the data transmission module 23, and the data transmission module 23 transmits metering data provided by the metering module 21 to a terminal, thereby realizing a remote intelligent meter reading function of the self-powered water meter. The intelligent water meter module 2 may be entirely or partially mounted in the first cavity 11. The specific structure of the intelligent water meter module 2 may be an existing intelligent water meter module and is not elaborated herein.

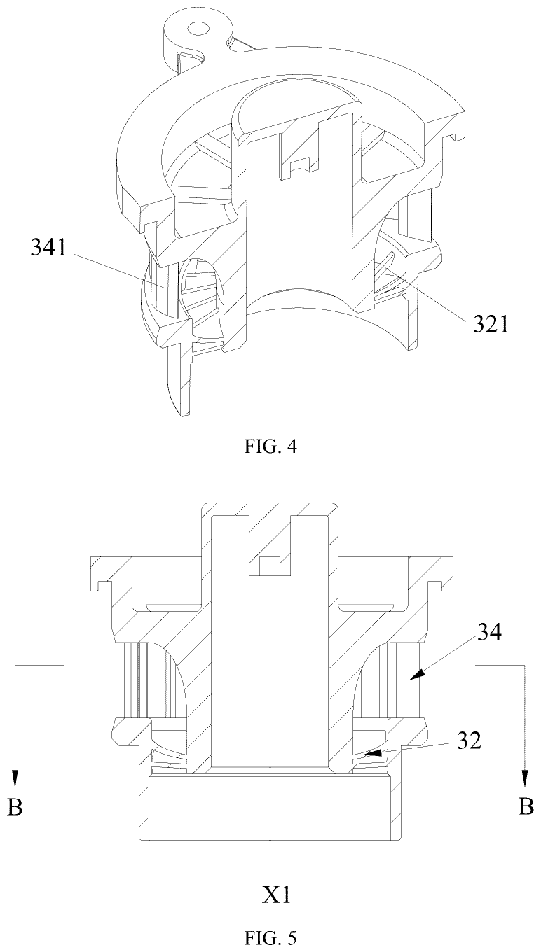

The power generating module 3 includes a generator 31, a first flow guide structure 32, and a power generating impeller 33, and the power generating module 3 may be entirely or partially mounted in the second cavity 12. As shown in FIGS. 4-7, the first flow guide structure 32 includes a set of first guide vanes 321, 10-60 first guide vanes 321 are provided, each first guide vane 321 has a first blade bending angle α, the first blade bending angle α is 50-75 degrees, the first flow guide structure 32 guides a water flow towards the power generating impeller 33, and the power generating impeller 33 rotates such that the generator 31 generates power. FIG. 7 is a schematic longitudinal sectional view of the first guide vane as viewed radially from the first flow guide structure. As shown in FIG. 7, the first blade bending angle α is an angle between the tangential direction of the centerline on the outlet side of the first guide vane and a central axis X1 of the first flow guide structure.

Adding components in the housing inevitably increases pressure loss because the water flow is obstructed by various components, causing multiple changes. With the arrangement of a specific quantity of first guide vanes at special angles, the first flow guide structure of this embodiment can guide the water flow to the power generating impeller at an appropriate angle and reduce turbulence of the water flow in the second cavity as much as possible, thereby reducing pressure loss. In other words, the first flow guide structure of this embodiment increases the electricity generating power of the power generating impeller on the premise of reducing the increase in pressure loss as much as possible.

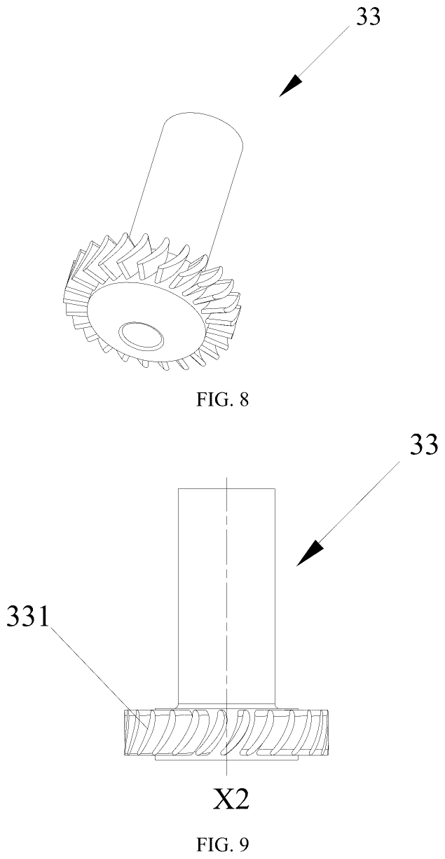

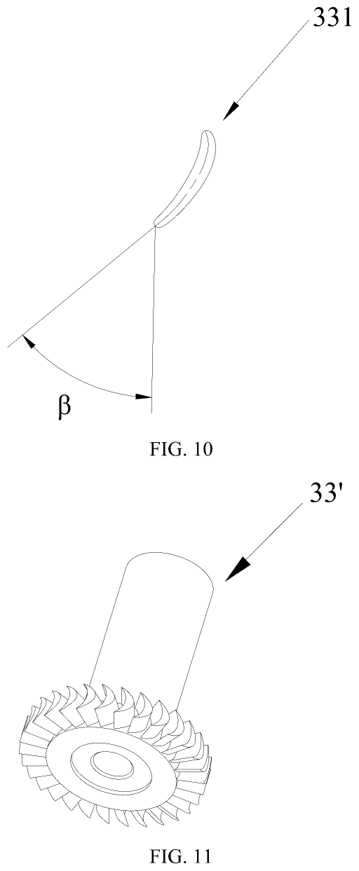

In this embodiment, as shown in FIGS. 8-10, the power generating impeller 33 includes a set of power generating blades 331, 10-60 power generating blades 331 are provided, each power generating blade 331 has a second blade bending angle β, and the second blade bending angle β is 15-40 degrees. FIG. 10 is a schematic longitudinal sectional view of the power generating blade as viewed radially from the power generating impeller. As shown in FIG. 10, the second blade bending angle β is an angle between the tangential direction of the centerline on the water outlet side of the blade and an axis X2 of the power generating impeller. With the arrangement of a specific quantity of power generating blades at special angles, the power generating impeller of this embodiment can ensure a certain electricity generating power even under a condition of a small water flowing speed. In the prior art, the power generating impeller of the self-powered water meter is a conventional impeller. When the water flowing speed is too low, it is below the self-starting speed, and the rotation of the power generating impeller cannot provide a sufficient power generation capacity. In this case, if a homeowner is economical with water and always uses a small water flow, the self-powered water meter cannot generate power. The power generating impeller provided by this embodiment avoids this problem. With a quite small increase in pressure loss, the impeller can self-start to generate power at a water speed of 0.5 m³/h, and the power generation capacity is greater than 1 mA. In the prior art, if the impeller needs to self-start to generate power at this water speed, it is necessary to reduce the diameter of the through hole between the first cavity and the second cavity, making the diameter quite small to increase the water speed in the second cavity, such that the power generating impeller can reach the rotational speed at which a sufficient power generation capacity is provided. However, this causes a significant increase in pressure loss. However, the self-powered water meter of the present invention resolves the problem of increased pressure loss through the design of the flow guide structure and the power generating impeller.

This embodiment, through the combination of the first flow guide structure and the power generating impeller, ensures that the overall pressure loss of the self-powered water meter is within the national standard range and that the self-powered water meter can still generate power under a condition of a small water flow, making the commercial application and promotion of the self-powered water meter possible.

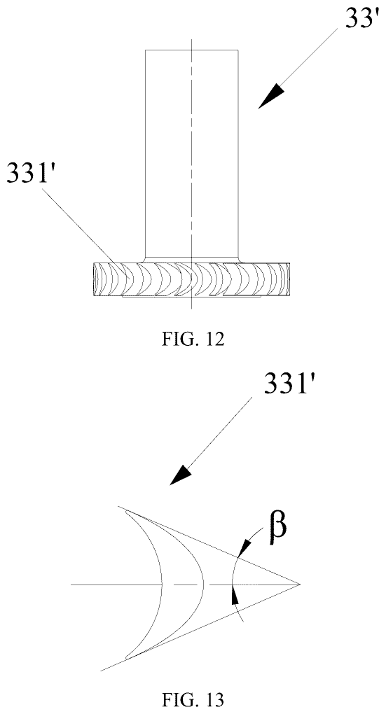

In this embodiment, each power generating blade 331 is an asymmetric blade, allowing for better use of the kinetic energy of the water flow impact. However, the present invention does not make any limitations on this. In another embodiment, as shown in FIGS. 11 to 13, a power generating blade 331′ included by a power generating impeller 33′ may be a symmetric blade. In this embodiment, the second blade bending angle β of the power generating blade 331′ is 0-60 degrees. In this embodiment, the second blade bending angle β is an angle between the tangential direction of the blade tip curve and the symmetric line of the center of the blade. When β is 0 degrees, the longitudinal section of the second blade is semicircular.

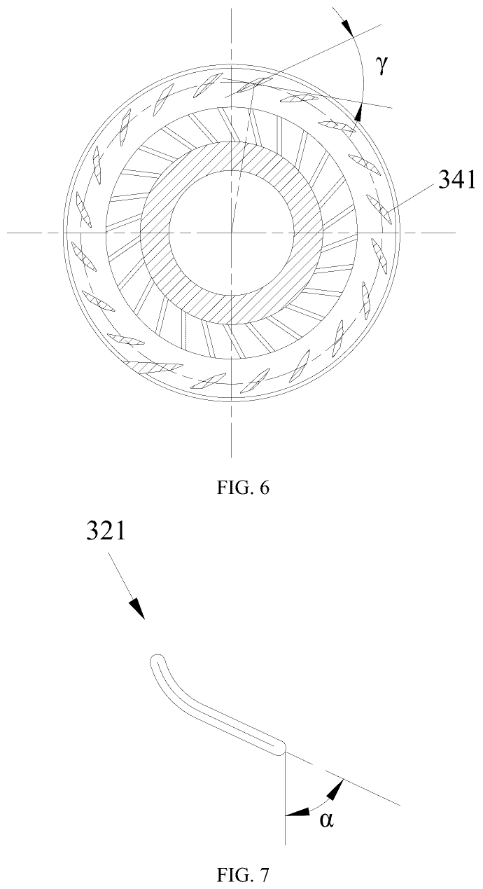

As shown in FIGS. 4-6, in this embodiment, the power generating module 3 further includes a second flow guide structure 34, and the second flow guide structure 34 guides the water flow to the first flow guide structure 32. The second flow guide structure 34 includes a set of second guide vanes 341, 10-40 second guide vanes 341 are provided, and each second guide vane 341 has a blade inclination angle γ, and the blade inclination angle γ is 10-60 degrees. In this embodiment, the second guide vanes are tongue-shaped blades, but the present invention does not make any limitations on the specific shape of the second guide vanes. As shown in FIG. 6, the blade inclination angle γ is an angle between the central axis of the second guide vane and the tangential direction of the center circle of the second guide vane.

In this embodiment, a quantity of second guide vanes 341 is less than a quantity of first guide vanes 321, and a blade gap between the second guide vanes 341 is greater than a blade gap between the first guide vanes 321. Through such arrangement, the water flow on the way to the second cavity is not subjected to much resistance when it first collides with the second flow guide structure. For the water flow in the second cavity, the second flow guide structure mainly serves to divert and guide the flow, minimizing turbulence due to obstruction to the water flow, thereby reducing the increase in pressure loss as much as possible.

In this embodiment, the second flow guide structure guides the water flow from top to bottom to the first flow guide structure, and then the first flow guide structure guides the water flow from top to bottom to all the blades of the power generating impeller. In the prior art, the water flow directly impacts some of the blades of the power generating impeller laterally, thereby driving the entire power generating impeller to rotate. In other words, after the water flow exits the first cavity, it directly impacts a few power generating blades of the power generating impeller located in the second cavity from left to right, with each impact occurring at one or several points. In this embodiment, the water flow passes through the first flow guide structure and the power generating impeller structure and then is entirely guided to impact all the blades of the power generating impeller, taking advantage of both the kinetic energy and gravitational potential energy of the water flow, thereby increasing the electricity generating power. However, the present invention does not make any limitations on this. In other embodiments, the first flow guide structure may be located below the power generating impeller, guiding the water flow from bottom to top to the power generating impeller. Although the gravitational potential energy of the water flow is not used, the water flow is guided to all the power generating blades of the power generating impeller. Whether it is located above or below, as long as the first flow guide structure is upstream of the impeller.

In this embodiment, the diameter of the first flow guide structure is smaller than the diameter of the second flow guide structure, and the diameter of the first flow guide structure is greater than the diameter of the power generating impeller. In other words, the diameters sequentially decrease from the second flow guide structure to the first flow guide structure and then to the power generating impeller. With such arrangement, the water flow becomes more concentrated and faster after guided by the flow guide structures, ensuring a certain electricity generating power under a condition of a small water flow.

The first flow guide structure and the second flow guide structure can direct the water flow and increase the speed of the water flow, allowing for more regular and smooth flowing, thus further reducing turbulence and pressure loss. Compared with the existing self-powered water meters, the self-powered water meter used in this embodiment directly reduces the pressure loss from over 100 kPa to 60 kPa. For the conventional intelligent power-generating water meter, the metering module has a pressure loss of around 40 kPa. The self-powered water meter provided in this embodiment, in a case of merely an increased 20 kPa pressure loss, achieves the power generation effect of the prior art where an over 100 kPa pressure loss is increased.

In summary, the self-powered water meter with a power generating module provided in the present invention can self-start to efficiently generate power even at a low water speed. When the water speed is greater than 0.5 m³/h, a power generating current exceeds 1 mA without significantly increasing pressure loss, making the self-powered water meter viable for commercial use and promotion.

It should be noted that “above” and “below” in this application are distinguished along the direction of gravity. “Above” and “below” in this application are orientations defined when the dial of the water meter faces upwards. When the dial of the water meter is mounted facing downwards, “above” is correspondingly changed to “below” and “below” is correspondingly changed to “above.” When the water meter is rotated 90 degrees, “above” and “below” are respectively correspondingly changed to “left” and “right.” The terms “first,” “second,” and the like in this application are set for convenience in describing the technical solutions of the present invention and do not have specific limiting effects. They are general references and do not limit the technical solutions of the present invention. The angles described in this application each include both endpoint values. It should be noted that, in a case of no conflict, the embodiments and features in the embodiments of this application can be combined with each other.

Although the invention has been disclosed by the preferred embodiment as above, it is not intended to limit the invention, and anyone skilled in the art may make slight changes and modifications without departing from the spirit and scope of the invention, so the protection scope of the invention shall be subject to the protection scope as claimed in the claims.

1. A self-powered water meter, comprising:
a housing having a first cavity and a second cavity, wherein the second cavity communicates with the first cavity;
an intelligent water meter module mounted in the first cavity; and
a power generating module mounted in the second cavity, wherein the power generating module comprises a generator, a first flow guide structure, and a power generating impeller, the first flow guide structure comprises a set of first guide vanes, 10-60 first guide vanes are provided, each of the first guide vanes has a first blade bending angle, the first blade bending angle is 50-75 degrees, the first flow guide structure guides a water flow towards the power generating impeller, and the power generating impeller rotates such that the generator generates power.

2. The self-powered water meter according to claim 1, wherein the power generating impeller comprises a set of power generating blades, 10-60 power generating blades are provided, each of the power generating blades is an asymmetric blade, each of the power generating blades has a second blade bending angle, and the second blade bending angle is 15-40 degrees.

3. The self-powered water meter according to claim 1, wherein the power generating impeller comprises a set of power generating blades, 10-60 power generating blades are provided, each of the power generating blades is a symmetric blade, each of the power generating blades has a second blade bending angle, and the second blade bending angle is 0-60 degrees.

4. The self-powered water meter according to claim 1, wherein the power generating module further comprises a second flow guide structure, the second flow guide structure guides the water flow to the first flow guide structure, the second flow guide structure comprises a set of second guide vanes, 10-40 second guide vanes are provided, each of the second guide vanes has a blade inclination angle, and the blade inclination angle is 10-60 degrees.

5. The self-powered water meter according to claim 4, wherein the second flow guide structure guides the water flow from top to bottom to the first flow guide structure, and the first flow guide structure guides the water flow from top to bottom to the power generating impeller.

6. The self-powered water meter according to claim 1, wherein the second cavity communicates with the first cavity via a through hole, and a diameter of the through hole is substantially consistent with an inner diameter of an external water pipe of the self-powered water meter.

7. A power generating module of a self-powered water meter, comprising:
a generator, a first flow guide structure, and a power generating impeller, wherein the first flow guide structure comprises a set of first guide vanes, 10-60 first guide vanes are provided, each of the first guide vanes has a first blade bending angle, the first blade bending angle is 50-75 degrees, the first flow guide structure guides a water flow towards the power generating impeller, and the power generating impeller rotates such that the generator generates power.

8. The power generating module of a self-powered water meter according to claim 7, wherein the power generating module further comprises a second flow guide structure, the second flow guide structure guides the water flow to the first flow guide structure, the second flow guide structure comprises a set of second guide vanes, 10-40 second guide vanes are provided, each of the second guide vanes has a blade inclination angle, and the blade inclination angle is 10-60 degrees.

9. The power generating module of a self-powered water meter according to claim 7, wherein the power generating impeller comprises a set of power generating blades, each of the power generating blades is an asymmetric blade, 10-40 power generating blades are provided, each of the power generating blades has a second blade bending angle, and the second blade bending angle is 15-40 degrees.

10. The power generating module of a self-powered water meter according to claim 7, wherein the power generating impeller comprises a set of power generating blades, 10-60 power generating blades are provided, each of the power generating blades is a symmetric blade, each of the power generating blades has a second blade bending angle, and the second blade bending angle is 0-60 degrees.
